(19) United States
(12) Patent Application Publication
(10) Pub. No.: US 2026/0281744 A1
(43) Pub. Date: Sep. 17, 2026

(54) METHOD AND APPARATUS OF SUPPORTING NETWORK OPTIMIZATION

(71) Applicant: LENOVO (BEIJING) LIMITED, Beijing (CN)

(72) Inventors: Congchi ZHANG, Shanghai (CN); Mingzeng DAI, Shanghai (CN); Shuigen YANG, Shanghai (CN); Le YAN, Shanghai (CN)

(21) Appl. No.: 19/168,027

(22) PCT Filed: Mar. 24, 2023
(86) PCT No.: PCT/CN2023/083759

§ 371 Date: Sep. 23, 2025

(51) Int. Cl. H04W 24/02; H04W 36/00; H04W 36/22

(52) U.S. Cl. CPC H04W 24/02; H04W 36/0044; H04W 36/22

(57) ABSTRACT

Embodiments of the present application are related to a method and apparatus of supporting network optimization. An exemplary method includes: transmitting, from a first RAN node to a second RAN node, a first message requesting first information related to network optimization operations associated with at least one cell of the first RAN node, wherein each network optimization operation is related to a cell of the at least one cell; receiving, from the second RAN node, at least a second message in response to the first message; and determining how to perform network optimization at least based on the second message before or after handovers in each cell of the at least one cell.

### TECHNICAL FIELD

The present disclosure is related to wireless communication, especially, related to techniques of network optimization in wireless communication.

### BACKGROUND OF THE INVENTION

A wireless communication system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, frames, subframes, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

On the other hand, 3rd generation partnership program (3GPP) has been considering to introduce artificial intelligence (AI) into 3GPP since 2016, including several study items and work items in SA1, SA2, SA5 and radio access network (RAN)3. In release (Rel) 18, 3GPP RAN3 is specifying procedures and signalling to support data (or information or the like) collection for AI based network optimization, such as load balancing (LB), energy saving (ES), and mobility optimization (MO). Regarding AI, it at least includes machine learning (ML) and is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” (or “AI/ML model” or “model” etc.) to learn how to solve problems and/or optimize performance from vast amounts of data. If AI models used on AI-based methods are well trained, the AI-based methods can obtain better performance than traditional methods.

### SUMMARY

Some embodiments of the present disclosure provide an apparatus of supporting network optimization, e.g., a source RAN node, which includes: a processor; and a transceiver coupled to the processor, wherein the transceiver is configured to: transmit, from a first RAN node to a second RAN node, a first message requesting first information related to network optimization operations associated with at least one cell of the first RAN node, wherein each network optimization operation is related to a cell of the at least one cell; receive, from the second RAN node, at least a second message in response to the first message; and determine how to perform network optimization at least based on the second message before or after handovers in each cell of the at least one cell.

Some embodiments of the present disclosure provide a method of supporting network optimization, e.g., performed by a source RAN node, which includes: transmitting, from a first RAN node to a second RAN node, a first message requesting first information related to network optimization operations associated with at least one cell of the first RAN node, wherein each network optimization operation is related to a cell of the at least one cell; receiving, from the second RAN node, at least a second message in response to the first message; and determining how to perform network optimization at least based on the second message before or after handovers in each cell of the at least one cell.

In some embodiments of the present disclosure, the first message also indicates information of cells of the second RAN node that will be impacted by the network optimization operations associated with at least one cell of the first RAN node.

According to some embodiments of the present disclosure, the second message indicates at least one of the following: accepted cells to which the second RAN node allows the first RAN node to handover UE; rejected cells to which the second RAN node rejects the first RAN node to handover UE; or suggested cells to which the second RAN node suggests the first RAN node to handover UE.

According to some embodiments of the present disclosure, for a cell of the second RAN node, the first information includes at least one of the following: information of estimated energy cost in the case of offloading traffic to the cell; or information of estimated UE performance in the case of UEs being handed over to the cell.

In some cases of the present disclosure, the first message indicates validity time associated with the first information to be provided in the second RAN node.

According to some embodiments of the present disclosure, the first message also indicates information of the at least one cell of the first RAN node.

In some embodiments of the present disclosure, the first message also indicates information of the network optimization operations.

According to some embodiments of the present disclosure, the information of the network optimization operations indicates at least one of the following: whether a network optimization operation is related to energy saving operation; whether a network optimization operation is related to load balancing operation; or whether cells of the first RAN node impacted by a network optimization operation is going to be switched off.

According to some embodiments of the present disclosure, the information of the network optimization operations indicates estimated time when an associated network optimization operation is expected to be performed.

In some embodiments of the present disclosure, the processor is configured to: receive a third message including part or all of the first information; and determine how to perform network optimization at least based on the second message and third message.

In some embodiments of the present disclosure, determining how to perform network optimization at least based on the second message comprises determine whether to perform handovers.

In some embodiments of the present disclosure, the processor is configured to: transmit, to the second RAN node, a fourth message requesting UE related feedback after UEs being handed over to the second RAN node, wherein the fourth message is the first message or separate from the first message; and after handing over an associated UE to the second RAN node, receive at least one of the UE related feedback of the UE or information indicating stop providing the UE related feedback of the UE.

According to some embodiments of the present disclosure, the UE related feedback comprises at least one of: UE performance feedback, UE mobility feedback, or UE traffic feedback.

According to some embodiments of the present disclosure, the processor is configured to transmit a plurality of fourth messages, wherein, different fourth messages are associated with different kinds of UE related feedback.

In some cases, the processor is configured to: transmit identification information of at least one of the plurality of fourth messages to the second RAN node in a handover request message for the UE; or indicate to the second RAN node that all kinds of UE related feedback are requested in a handover request message for the UE.

According to some embodiments of the present disclosure, the information indicating stop providing the UE related feedback of the UE indicates at least one of the following: an indicator indicating stop providing the UE related feedback; one or multiple indicators indicating causes of stop providing the UE related feedback; a radio resource control (RRC) state that the UE enters; identification information of a cell to which the UE is handed over by the second RAN node; or identification information of a RAN node to which the UE is handed over by the second RAN node.

According to some embodiments of the present disclosure, the information indicating stop providing the UE related feedback for different UEs is included in a same IE or different IEs.

According to some embodiments of the present disclosure, the information indicating stop providing the UE related feedback is included in an IE same as or different from an IE used to provide the UE related feedback.

According to some embodiments of the present disclosure, the processor is configured to: delete related context of the UE at the first RAN node after receiving the information indicating stop providing the UE related feedback of the UE.

According to some embodiments of the present disclosure, the information indicating stop providing the UE related feedback for the UE is included a UE context release message.

Some embodiments of the present disclosure provide another apparatus of supporting network optimization, e.g., a target RAN node, which includes: a processor; and a transceiver coupled to the processor, wherein the transceiver is configured to: receive, from a first RAN node by a second RAN node, a first message requesting first information related to network optimization operations associated with at least one cell of the first RAN node, wherein each network optimization operation is related to a cell of the at least one cell and is expected to be performed before or after handovers in the cell; and transmit, from the second RAN node, at least a second message in response to the first message.

In some embodiments of the present disclosure, the processor is configured to: transmit a third message including part or all of the first information.

In some embodiments of the present disclosure, the processor is configured to: receive, from the first RAN node, a fourth message requesting UE related feedback after UEs being handed over to the second RAN node, wherein the fourth message is the first message or separate from the first message; and after an associated UE being handed over to the second RAN node, transmit at least one of the UE related feedback of the UE or information indicating stop providing the UE related feedback of the UE.

According to some embodiments of the present disclosure, the processor is configured to receive a plurality of fourth messages, wherein, different fourth messages are associated with different kinds of UE related feedback.

In some cases, the processor is configured to: receive identification information of at least one of the plurality of fourth messages from the first RAN node in a handover request message for the UE; or indicate to the second RAN node that all kinds of UE related feedback are requested in a handover request message for the UE.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 is a flow chart illustrating an exemplary method of supporting network optimization according to some embodiments of the present disclosure.

FIG. 2 is a flow chart illustrating an exemplary method of supporting network optimization mainly in view of Cases 1 according to some embodiments of the present disclosure.

FIG. 3 is a schematic diagram illustrating exemplary scenarios of Cases 1 where a method of supporting network optimization is applied according to some embodiments of the present disclosure.

FIG. 4 is a flow chart illustrating an exemplary method of supporting network optimization mainly in view of Cases 2 according to some embodiments of the present disclosure.

FIG. 5 is a flow chart illustrating an exemplary method of supporting network optimization mainly in view of Cases 2 according to some other embodiments of the present disclosure.

FIG. 6 illustrates a block diagram of an apparatus of supporting network optimization according to some embodiments of the present disclosure.

FIG. 7 illustrates a block diagram of an apparatus of supporting network optimization according to some other embodiments of the present disclosure.

### DETAILED DESCRIPTION

Network optimization, such as load balancing, energy saving, and mobility optimization is always concerned during the development of the wireless communication technology. According to the latest 3GPP discussion, at least the following issues need to be addressed to at least improve network optimization techniques.

One issue is: how to improve data collection procedure(s) associated with network optimization, e.g., data collection request, response and/or update etc., so as to help a RAN node, e.g., a source gNB make proper network optimization decision(s) and/or handover (HO) decision(s).

Another issue is: in the case that a UE handed over from a source gNB to a target gNB is associated with more than one kind of UE related feedback, how to request the more than one kind of UE related feedback from the target gNB by the source gNB and how to provide the more than one kind of UE related feedback to the source gNB by the target gNB need to be solved.

Yet another issue is: in some cases, the target gNB may not be able to provide the requested UE related feedback. For example, in the case that the UE is handed over to another cell and/or another gNB, or in the case that the UE enters a RRC non-connected state, e.g., RRC inactive state or RRC idle state, or in the case of radio link failure (RLF). How to handle these cases should be solved.

At least to solve the above issues, embodiments of the present disclosure provide a technical solution of supporting network optimization. In some scenarios, e.g., a RAN node performing network optimization is an AI able RAN node (or AI based RAN node or AI support RAN node etc.), the network optimization may be AI-based network optimization.

For example, some embodiments of the present disclosure provide a RAN node, e.g., a source gNB, which may be configured to: transmit, from the RAN node to another RAN node, e.g., a target gNB, a first message requesting first information related to network optimization operations, e.g., LS, ES or MO etc., associated with at least one cell of the RAN node. In the case of AI based network optimization, an exemplary first message is the same as the message used to request predicted resource status from the peer RAN node agreed in 3GPP. Each network optimization operation is related to a cell of the at least one cell. The RAN node may be further configured to: receive, from the other RAN node, at least a second message in response to the first message; and determine how to perform network optimization at least based on the second message before or after handovers in each cell of the at least one cell.

For another example, some other embodiments of the present disclosure also provide a RAN node, e.g., a target gNB, which may be configured to: receive, from another RAN node, e.g., a source gNB, a first message requesting first information related to network optimization operations, e.g., LS, ES or MO etc., associated with at least one cell of the other RAN node. Each network optimization operation is related to a cell of the at least one cell and is expected to be performed before or after handovers in the cell. The RAN node may be further configured to: transmit to the other RAN node, at least a second message in response to the first message.

Embodiments of the present disclosure will improve network optimization techniques, especially will improve AI based network optimization in the case of AI-based RAN being supported, and thus facilitate and improve the implementation of new radio (NR).

Reference will now be made in detail to some embodiments of the present disclosure, examples of which are illustrated in the accompanying drawings.

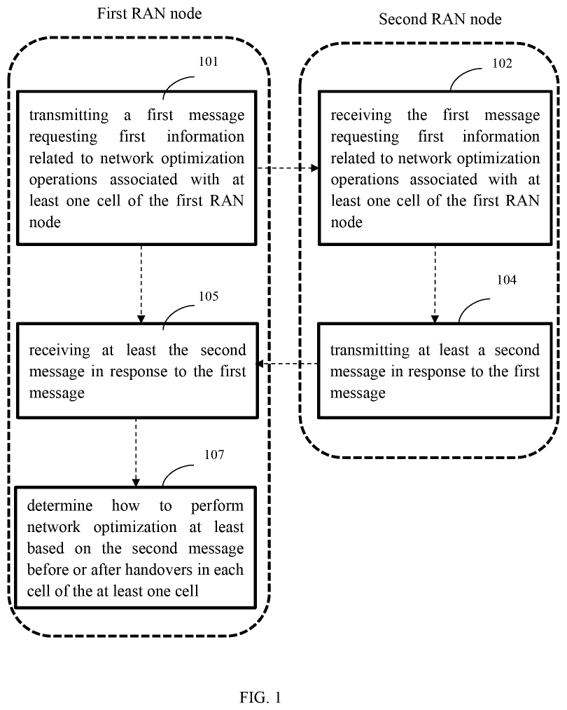

FIG. 1 is a flow chart illustrating an exemplary method of supporting network optimization according to some embodiments of the present disclosure. Although the method is illustrated in a system level by a first RAN node and a second RAN node, persons skilled in the art would understand that the method implemented in the two RAN nodes can be separately implemented and incorporated by other apparatus with the like functions.

Referring to FIG. 1, in step 101, a first RAN node, e.g., a first gNB, may transmit a message (hereafter, a first message) requesting information (hereafter, the first information) related to network optimization operations to a second RAN node, e.g., a second gNB. The network optimization operations are associated with at least one cell of the first RAN node, wherein each network optimization operation is related to a cell of the at least one cell. The first RAN node may initiate transmitting the first message for collecting information (or data) related to network optimization in various scenarios or for different purposes, which may be referred to a data collection procedure or the like in some embodiments of the present disclosure. The first message may be referred to as a data collection request message, a data collection request or the like. The requested information related to network optimization operations may include information related to network optimization operations before HO decisions (or HOs) (first information before HO decisions or first information before HOs) and information related to network optimization operations after HOs (first information after HOs). For a cell of the second RAN node, exemplary first information before HO decisions may include at least one of the following: information of estimated energy cost in the case of offloading traffic to the cell; or information of estimated UE performance in the case of UEs being handed over to the cell. Besides, exemplary first information after HOs may include UE related feedback after HOs.

For example, in some exemplary scenarios (hereafter, Cases 1), the first RAN node, e.g., the source gNB may initiate a data collection procedure before making network optimization decisions (including HO decisions) to help make proper network optimization, e.g., LB, ES, MO and/or HO decision. In an exemplary scenario, a source gNB may tend to switch off a cell thereof and handover all ULEs in the cell to a target gNB, and then the source gNB may request information related to network optimization, e.g., use a class 1 procedure agreed by 3GPP RAN3 over Xn interface to request estimated energy cost caused by the potential HOs from the target gNB. In some cases, e.g., in the case of AI based network optimization, the source gNB may use the message of requesting predicted resource status over Xn interface to request estimated energy cost.

In some other exemplary scenarios (hereafter, Cases 2), the source gNB may initiate a data collection procedure to request information related to network optimization after HOs from the target gNB, e.g., UE related feedback. Exemplary UE related feedback may include UE performance feedback (e.g., uplink (UL)/downlink (DL) throughput, packet delay, packet error rate etc.), UE mobility feedback (e.g., UE trajectory etc.), and UE traffic feedback (e.g., UE traffic load etc.) and so on. The source gNB may expect the target gNB to send back the requested UE related feedback after handing over the UE(s) to the target gNB. For example, the source gNB may initiate a data collection procedure to request UE performance feedback to determine whether an associated HO decision is good or not. For another example, the source gNB may initiate a data collection procedure to request UE trajectory or UE traffic feedback after HO from the target gNB to determine whether the UE trajectory or UE traffic previously predicted by the source gNB is accurate or not. In the case that the RAN node is an AI based RAN node, based on the UE related feedback, the RAN node can monitor whether the AI model is performing good and trigger AI model update when necessary.

Exemplary Cases 1 and Cases 2 are only used for illustrating the scenarios and/or purposes of transmitting the first message, but are not used to limit the related procedures or messages. In some embodiments of the present disclosure, the first message may include both the first information before HO decisions, e.g., exemplary first information requested in view of Cases 1 (such as estimated LB, or ES), and the first information after HOs, e.g., exemplary first information requested in view of Cases 2 (such as UE related feedback). In some embodiments of the present disclosure, there may be multiple first messages, which are used to request different kinds of information of network optimization operations, e.g., requesting for only the first information before HO decisions, or for only first information after HOs, or for both first information before HO decisions and first information after HOs.

Accordingly, the second RAN node will receive the first message in step 102. After receiving the first message, the second RAN node will determine whether it is able to provide the information requested or whether the request in the first message can be allowed in the first message. If it is unable to or does not allow, the second RAN node may reject the request. If it is able to or allow, the second RAN node will collect (e.g., estimate, or determine or calculate etc.) the information or data requested in the first message.

The second RAN node will transmit a message (hereafter, the second message) in response to the first message to the first RAN node in step 104. Accordingly, the first RAN node will receive the second message in response to the first message to the first RAN node in step 105. For the same first message, there may be one or more second messages to the first RAN node. In addition, the second messages are various in different embodiments of the present disclosure. For example, the second message may indicate the request in the first message is allowed (which may be referred to as a data collection response or the like) or is rejected (which may be referred to as a data collection response or a data collection failure or the like). If the request is allowed, the second RAN node may further transmit one or more second messages to the first RAN node to provide the requested first information (partial or all), which may be referred to as a data collection update, or data update or the like.

After receiving the second messages, the first RAN node will determine how to perform network optimization before or after HOs in each cell associated with the network optimization operations in step 107, which is at least based on the received second messages. In some embodiments of the present disclosure, determining how to perform network optimization at least based on the second message includes determine whether to perform handovers. For example, as the above illustrated in view of Cases 1, the first gNB may tend to switch off a cell and handover all UEs in the cell to a second gNB and request estimated energy cost caused by the possible HOs at the target gNB. Then, after receiving the second message from the target gNB, the first gNB will take into account the second message when decides to switch off the cell. The first gNB may switch off the cell only in the case that the estimated energy cost at the second gNB is less than the reduced energy cost at the first gNB and make handover decisions for associated UEs in the cell. In some other scenarios, the second gNB may reject the request from the first gNB. Then, the first gNB may decide not to perform expected network optimization operations, e.g., not switching off the cell and not handing over the UEs in the cell to the second gNB; or select another cell in the target gNB or another gNB to handover the UEs in the cell.

In some scenarios, the first RAN node, e.g., the source gNB may request the first information with different configurations, e.g., different kinds of UE related feedbacks from the second RAN node, e.g., the second gNB. The different kinds of UE related feedback may be transmitted via separate first messages, and each is identified by an identifier or index etc. For each associated UE, the first RAN node may include the identification information of the related first messages (e.g., more than one identifier or index etc.) in the handover request message, such that the HO will be associated with more than one related data request. The target gNB will measure and provide the UE related feedback as required separately after the associated UE is handed over to the target gNB.

In addition, in the case that the target gNB is requested to provide UE related feedback to the source gNB, the target gNB may fail to provide the requested feedback for one or more UEs due to HO to another cell or gNB, RRC state switch, or RLF etc. The target gNB may inform the source gNB about that, e.g., indicating stop providing the UE related feedback of the one or more UEs, so that the source gNB does not need to keep the UE context or AI context of the one or more UEs.

More detailed embodiments of the present disclosure are illustrated in the following respectively mainly in view of Cases 1 and Cases 2. As aforementioned, persons skilled in the art should well know that although the following embodiments are illustrated respectively in view of Cases 1 and Cases 2 for simplification and clearness, they can be combined as desired in some embodiments of the present disclosure.

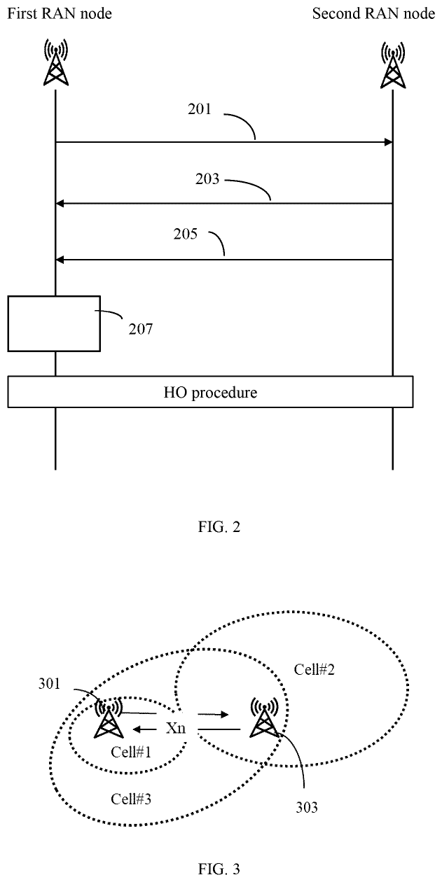

FIG. 2 is a flow chart illustrating an exemplary method of supporting network optimization mainly in view of Cases 1 according to some embodiments of the present disclosure. Similarly, although the method is illustrated in a system level by a first RAN node and a second RAN node, persons skilled in the art would understand that the method implemented in the two RAN nodes can be separately implemented and incorporated by other apparatus with the like functions.

Referring to FIG. 2, to make proper network optimization decision(s) (including HO decision(s)), the first RAN node may transmit a first message to request information related to network optimization operations before HO decisions in step 201, which may be a data collection request message or the like. For example, the first RAN node may plan to handover one or more UEs to the second RAN node to optimize network, e.g., for load balancing and/or energy saving etc., and may request the estimated energy cost caused by the planned handovers. For another example, the first RAN node may request the second RAN node to provide estimated UE performance if handing over UEs to the second RAN node, e.g., estimated UL/DL throughput, packet delay, and/or packet error rate etc. The network optimization operations are associated with one or more cells of the first RAN node. The network optimization operations in each cell may cause HO decisions for UEs in the cell or not.

Beside requesting information related to network optimization operations, the first message may also include other information to enhance the following network optimization decisions and/or HO decisions.

For example, in some embodiments of the present disclosure, the first message may indicate information of cells of the second RAN node that will be impacted by the network optimization operations associated with at least one cell of the first RAN node, so that there will be negotiations between the two RAN nodes (e.g., the source and target gNB) to optimize network optimization decisions, especially for load balancing and energy saving purposes in the case that a group of UEs will be handed over from the first RAN node to the second RAN node. For example, due to load balancing or energy saving reasons, a source gNB may plan to handover multiple UEs to one or multiple cells at the target gNB. In this case, when requesting the estimated energy cost (or estimated additional energy cost) caused by the handovers of UEs at the target gNB, the source gNB may also indicate the candidate target cell(s) that will be impacted by the handovers. When calculating the estimated energy cost, the target gNB may consider the characteristics in those specific candidate target cell(s) to provide more accurate results.

In some other embodiments of the present disclosure, the first message may also indicate information of the at least one cell of the first RAN node, which will be impacted by the network optimization operations.

In some yet other embodiments of the present disclosure, the first message may also indicate information of the network optimization operations. For example, the information of the network optimization operations may indicate at least one of the following: whether a network optimization operation is related to energy saving operation; whether a network optimization operation is related to load balancing operation; or whether cells of the first RAN node impacted by a network optimization operation is going to be switched off. In some cases, the information of the network optimization operations may also indicate estimated time when an associated network optimization operation is expected to be performed. For example, in the case that the network optimization operation is to switch off a cell, the source gNB may further indicate the time when the source cell is expected to be switched off.

In some yet other embodiments of the present disclosure, the first message may also indicate validity time associated with the first information to be provided in the second RAN node. For example, in the case that the source gNB requests the target gNB to provide estimated energy cost or estimated UE performance feedback (or estimated UE performance), the source gNB may further indicate the validity time associated with the estimation, e.g., a time window for which the estimation is.

After receiving the first message, the second RAN node will transmit a second message in response to the first message in step 203, which may be a data collection response message or data collection failure message or the like. For example, the second RAN node may transmit a response to indicate whether the request and/or handover is allowed, especially in the case that the second RAN node needs time to collect the information requested by the first message. An exemplary second message may indicate: accepted cells to which the second RAN node allows the first RAN node to handover UE; rejected cells to which the second RAN node rejects the first RAN node to handover UE; and/or suggested cells to which the second RAN node suggests the first RAN node to handover UE.

In the case that, the second RAN node allows the first RAN node to handover UEs, it may further provide the requested information, e.g., estimated energy cost and/or estimated UE performance by another second message (or referred to a third message etc.) in step 205, which may be a data update message or the like.

Based on the received second message(s), the first RAN node will determine how to perform network optimization at least based on the second message(s) in step 207, which is received before HO decisions or after handovers in each cell of the first RAN node associated with the first message. For example, the first RAN node may make LB, ES and/or MO decisions and/or HO decisions based on the second messages (e.g., data collection response, or data update, or both data collection response and data update etc.). In the case that HO decision(s) in a cell is made, which may be caused by the LB, ES and/or MO decision(s) etc., a HO procedure will be performed for associated UE(s) in the corresponding cell of the first RAN node (a source cell).

FIG. 3 is a schematic diagram illustrating exemplary scenarios of Cases 1 where a method of supporting network optimization is applied according to some embodiments of the present disclosure.

Referring to FIG. 3, two RAN nodes, e.g., a first gNB 301 and a second gNB 303, and three cells, e.g., Cell #1, Cell #2 and Cell #3 are illustrated as an example. Wherein, Cell #1 belongs to the first gNB 301, and Cell #2 and Cell #3 belong to the second gNB 303. In addition, Cell #1 and Cell #3 have overlapped coverage. In some scenarios, the first gNB 301 may plan to switch off Cell #1 considering energy saving, which needs to handover UEs in Cell #1 to Cell #2 which belongs to the second gNB 303. Then, the first gNB 301 may initiate a data collection procedure by transmitting a message requesting information related to such network operations (switch off the cell and corresponding handovers). Besides requesting information associated with network optimization operations in Cell #1, e.g., estimated energy cost caused by the handover in the second gNB 303, the first gNB 301 may also indicate the impacted cells in the first gNB 301, e.g., Cell #1 and impacted cells in the second gNB 303, e.g., Cell #2 to the second gNB 303. After receiving the first message, the second gNB 303 may determine whether Cell #2 is able to support the additional UEs and traffic load from the first gNB 301 if Cell #1 is switched off. In the case that Cell #2 is currently overloaded or will be overloaded, the second gNB may reject the handovers to Cell #2. After receiving the message from the second gNB 303, the first gNB 301 may decide not switch off Cell #1 and not hand over UEs. In some other cases, the second gNB may suggest the source gNB hands over UE(s) in Cell #1 to Cell #3 that has overlapped coverage with Cell #1. After receiving the message from the second gNB 303, the first gNB 301 may switch off Cell #1 and hand over UEs in Cell #1 to Cell #3.

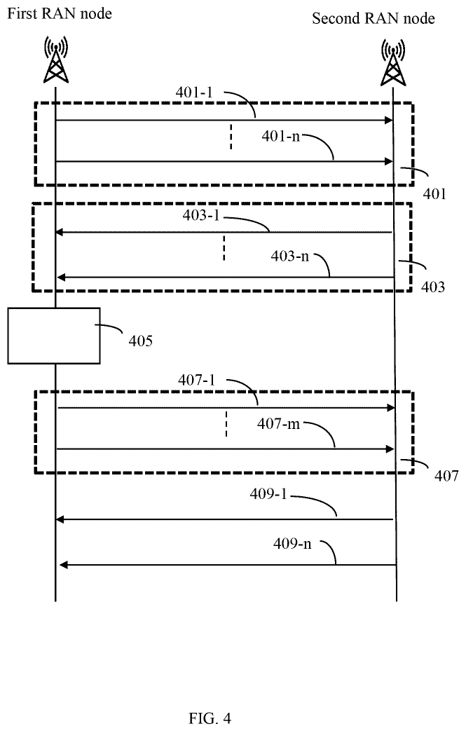

FIG. 4 is a flow chart illustrating an exemplary method of supporting network optimization mainly in view of Cases 2 according to some embodiments of the present disclosure. Similarly, although the method is illustrated in a system level by a first RAN node, e.g., a source gNB and a second RAN node, e.g., a target gNB, persons skilled in the art would understand that the method implemented in the two RAN nodes can be separately implemented and incorporated by other apparatus with the like functions.

Referring to FIG. 4, in some scenarios, the source gNB may request the target gNB to provide more than one kind of UE related feedback after HOs. The source gNB may transmit more than one first message requesting each kind of UE related feedback from the target gNB in step 401, and receive corresponding responses in step 403. That is, more than one data collection request will be initiated. For example, there are n (n>1) data requests respectively transmitted in steps 401-1 to 401-n. Accordingly, there are n data responses in response to the data requests in step 403-1 to 403-n.

Different data collection requests have different configurations, e.g., different contents of the UE related feedback, different time periods for the UE feedback etc. For example, the source gNB may transmit a data collection request to request UE performance feedback to determine whether a previous HO decision is good or not; and transmit another data collection request to request UE trajectory or UE traffic feedback to determine whether the previously predicted UE trajectory or UE traffic is accurate or not. Each first message (or data collection request or configuration) may be identified by an identifier or index. Exemplary identification information associated with each data collection request may be a measurement identifier as defined in legacy, or an AI event identifier novel over the legacy, or an AI even index novel over the legacy.

After receiving the second messages, the first RAN node will determine how to perform network optimization before or after HOs in each cell associated with the network optimization operations in step 405. In the case that the source gNB decides to handover one or more (m>=1) UEs to the target gNB, for each associated UE, the source gNB may indicate identification information of one or more associated data collection requests to the target gNB in step 407, e.g., via the handover request message respectively. For example, the source gNB may indicate the associated identification information to the target gNB via a handover request message for a first UE in step 407-1 (e.g., the first and second kind of UE related feedback), and for the m(th) UE (e.g., the first and n(th) kind of UE related feedback) in step 407-m.

Then, the target gNB will measure and provide the requested UE related feedbacks separately according to the data collection requests or configurations after handover completion in step 409. There are various manners of providing the requested UE related feedbacks after handover completion. Different messages can contain different kinds of UE related feedbacks. For example, the target gNB may provide the first kind of UE related feedback for the associated UEs (e.g., the first UE and the m(th) UE) in step 409-1, and provide the n(th) kind of UE related feedback for the associated UEs (e.g., the m(th)) in step 409-n.

In some scenarios, the source gNB may indicate that all kinds of UE related feedback are requested, e.g., setting a related parameter to be “all” or including all identifiers or indexes of the data collection requests. Accordingly, the target gNB will measure and provide all UE related feedback.

However, in some scenarios, the target gNB may fail to provide the UE related feedback for one or more UEs. According to some embodiments of the present disclosure, the target gNB will transmit information indicating stop providing the UE related feedback (or information indicating top of UE related feedback provision) of the UE to the source gNB. That is, after handing over an associated UE to the target gNB, the source gNB may receive only the UE related feedback, or only information indicating stop providing the UE related feedback, or both of them.

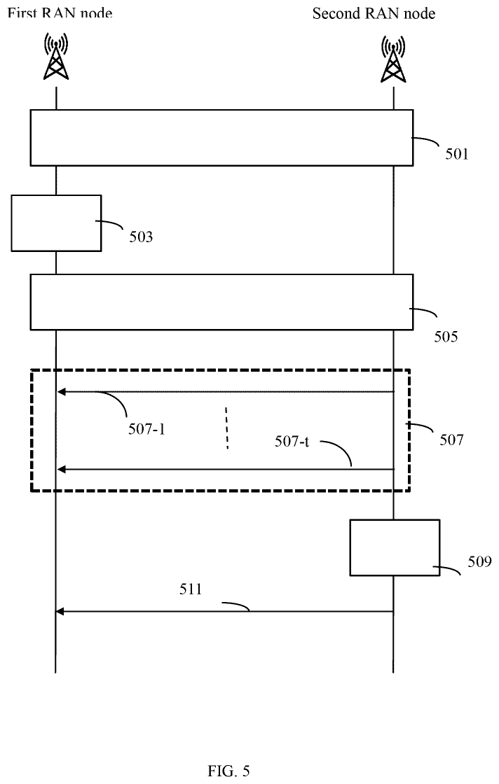

FIG. 5 is a flow chart illustrating an exemplary method of supporting network optimization mainly in view of Cases 2 according to some other embodiments of the present disclosure. Similarly, although the method is illustrated in a system level by a first RAN node, e.g., a source gNB, and a second RAN node, e.g., a target gNB, persons skilled in the art would understand that the method implemented in the two RAN nodes can be separately implemented and incorporated by other apparatus with the like functions.

Referring to FIG. 5, it is assumed the source gNB has requested the target gNB to provide UE related feedback after handover completion for one or more (m>=1) UEs in step 501, and made handover decisions for the one or more UEs in step 503. In the case that more than one kind of UE related feedback is requested, the identification information of associated data collection requests for each UE is also indicated to the target gNB, e.g., by respective handover request messages during the corresponding HO procedure in step 505. Details can refer to the above illustrated embodiments.

The target gNB will measure and provide the requested UE related feedback after the HOs in step 507, which may be transmitted in one or multiple (t>=1) data update messages. For example, the target gNB may provide the UE related feedback for the m UEs in step 507-1 to step 507-t.

However, in some scenarios, the target gNB may be unable to provide the UE related feedback for part or all of the one or more UEs anymore in step 509, e.g., in the case that the UE is further handed over to another cell/gNB, or the UE enters RRC inactive state or RRC idle state, or the UE experienced radio link failure. The target gNB will indicate to the source gNB that the target gNB will stop providing the UE related feedback of the associated UE in step 511. After receiving the message from target gNB about the feedback provision stop for certain UEs, the source gNB may delete the related UE context etc. from the source gNB.

Exemplary information indicating stop providing the UE related feedback of an associated UE may be: a general indicator indicating the stop of UE related feedback provision, an indicator indicating the causes of the stop of UE related feedback provision (e.g., handover, or UE enters RRC inactive, RRC idle state, or RLF etc.), or a RRC state (e.g., RRC inactive state or RRC idle state) that the UE enters, identification information of a cell to which the UE is handed over by the target gNB (e.g., a cell identifier that the UE is handed over to by the target gNB), and/or identification information of a RAN node to which the UE is handed over by the target gNB (e.g., a gNB identifier that the UE is handed over to by the target gNB) etc.

The information indicating stop providing the UE related feedback for different UEs may be included in the same IE or different IEs. The IE carrying the information indicating stop providing the UE related feedback may be the same as or different from that used to provide the UE related feedback.

In addition, the message from the target gNB to the source gNB that carries the UE related feedback may be UE associated (e.g., one UE per message) or non-UE associated (e.g., multiple UEs per message). The message carrying the information indicating stop providing the UE related feedback can be designed in a similar manner. In some cases, the UE related feedback and the information indicating stop providing the UE related feedback can be included in the same message (e.g., a data update message).

For example, in the message carrying the UE related feedback (and/or information indicating stop providing the UE related feedback), the target gNB may indicate the stop of UE related feedback provision as follows:
In the same IE providing (list of) UE related feedback, for each UE
   A general indicator indicating “the stop of UE related feedback provision”
   One or multiple indicators indicating the cause, which could be due to handover, or UE enters RRC inactive/idle state, or RLF
   A RRC state (e.g., RRC inactive or RRC idle state) that UE enters
   A new cellNB identifier that UE is handed over to;
   A new RAN node identifier, e.g., gNB identifier that UE is handed over to.

For another example, in the message carrying the UE related feedback (and/or information indicating stop providing the UE related feedback), the target gNB may indicate the stop of UE related feedback provision as follows:
In a novel IE different from the IE providing (list of) UE related feedback, e.g., UE Feedback Stop (List) IE, indicating the (list of) UE(s) that will no longer provide the feedback, for each UE
   One or multiple indicator indicating the cause, which could be due to handover, or UE enters RRC inactive/idle state, or RLF
   A RRC state (e.g., RRC inactive or RRC idle state) that UE enters
   A new cell/gNB identifier that UE is handed over to
   A new RAN node identifier e.g., gNB identifier that UE is handed over to.

In some embodiments of the present disclosure, the information indicating stop providing the UE related feedback may be added or implied in a UE context release message sent from the target gNB to the source gNB. For example, when the target gNB stops providing the UE related feedback for a UE, the target gNB will transfer a UE context release message to the source gNB to inform the source gNB that the context for the UE can be released. That implicitly indicates the target gNB will no longer provide the relevant UE feedback.

An exemplary novel XnAP message is illustrated in Table 1, which can be specified to indicate the stop of UE related feedback provision. Compared with the legacy XnAP message, an IE “UE related feedback stop list” is added, which further includes: UE ID, Cause, RRC state and new target cell ID.

TABLE 1

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.3.1 | | YES | ignore |
| NG-RAN node1 | M | INTEGER (1 . . . | Allocated by | YES | reject |
| Measurement ID | | 4095, . . . ) | NG-RAN node1 | | |
| NG-RAN node2 | M | INTEGER (1 . . . | Allocated by | YES | reject |
| Measurement ID | | 4095, . . . ) | NG-RAN node2 | | |
| UE related | | | | | |
| feedback list | | | | | |
| >UE ID | | | | | |
| >UE related feedback | | | | | |
| measurement | | | | | |
| UE related feedback | | | | | |
| stop list | | | | | |
| >UE ID | | | | | |
| >cause | | | Indicates the reason | | |
| | | | of stop | | |
| >RRC state | O | | RRC state that UE | | |
| | | | enters | | |
| >New target cell ID | O | | The new cell ID that | | |
| | | | UE is handed over to | | |

Besides the methods, embodiments of the present disclosure also propose an apparatus of supporting network optimization.

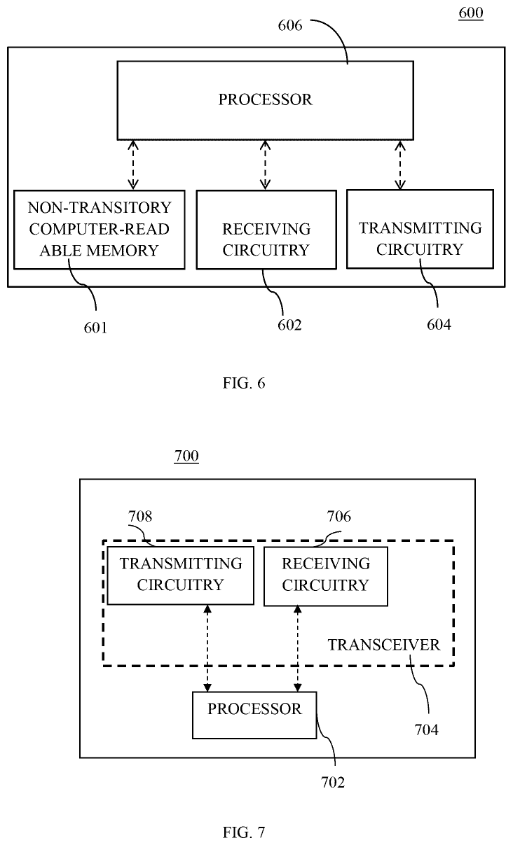

For example, FIG. 6 illustrates a block diagram of an apparatus of supporting network optimization 600 according to some embodiments of the present disclosure.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a central processing unit (CPU), a digital signaling processing (DSP), a microprocessor etc. The apparatus 600 may be a RAN node, e.g., a source gNB or a target gNB configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present disclosure, the receiving circuitry 602 and the transmitting circuitry 604 can be combined into a single device, such as a transceiver. In certain embodiments of the present disclosure, the apparatus 600 may further include an input device, a memory, and/or other components.

In some embodiments of the present disclosure, the non-transitory computer-readable medium 601 may have stored thereon computer-executable instructions to cause a processor to implement the method with respect to the RAN node, e.g., the source or target gNB as described above. For example, the computer-executable instructions, when executed, cause the processor 606 interacting with receiving circuitry 602 and transmitting circuitry 604, so as to perform the steps with respect to the RAN node as depicted above.

FIG. 7 is a block diagram of an apparatus of supporting network optimization 700 according to some other embodiments of the present disclosure.

Referring to FIG. 7, the apparatus 700, for example a RAN node may include at least one processor 702 and at least one transceiver 704 coupled to the at least one processor 702. The transceiver 704 may include at least one separate receiving circuitry 706 and transmitting circuitry 704, or at least one integrated receiving circuitry 706 and transmitting circuitry 704. The at least one processor 702 may be a CPU, a DSP, a microprocessor etc.

According to some embodiments of the present disclosure, the apparatus 700 is a first RAN node, e.g., a source RAN node or the like, which includes: a processor; and a transceiver coupled to the at least one processor, wherein the transceiver is configured to: transmit, from the first RAN node to a second RAN node, a first message requesting first information related to network optimization operations associated with at least one cell of the first RAN node, wherein each network optimization operation is related to a cell of the at least one cell; receive, from the second RAN node, at least a second message in response to the first message; and determine how to perform network optimization at least based on the second message before or after handovers in each cell of the at least one cell.

According to some embodiments of the present disclosure, the apparatus 700 is a second RAN node, e.g., a target RAN node, or candidate target RAN node or the like, which includes: a processor; and a transceiver coupled to the processor, wherein the transceiver is configured to: receive, from a first RAN node by a second RAN node, a first message requesting first information related to network optimization operations associated with at least one cell of the first RAN node, wherein each network optimization operation is related to a cell of the at least one cell and is expected to be performed before or after handovers in the cell; and transmit, from the second RAN node, at least a second message in response to the first message.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present disclosure provides an apparatus, including a processor and a memory. Computer programmable instructions for implementing a method are stored in the memory, and the processor is configured to perform the computer programmable instructions to implement the method. The method may be a method as stated above or other method according to an embodiment of the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method as stated above or other method according to an embodiment of the present disclosure.

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

To facilitate understanding, embodiments are provided under specific network architecture and new service scenarios, such as 3GPP 5G, 3GPP long-term evolution (LTE), and so on. It is contemplated that along with the developments of network architectures and new service scenarios, all embodiments in the present disclosure are also applicable to similar technical problems. Moreover, the terminologies recited in the present disclosure may change, which should not affect the principle of the present disclosure.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. An apparatus for wireless communication, comprising:
at least one memory; and
at least one processor coupled with the at least one memory and configured to cause the apparatus to:
transmit, from a first radio access network (RAN) node to a second RAN node, a first message requesting first information related to network optimization operations associated with one or more cells of the first RAN node, wherein each network optimization operation is related to a cell of the one or more cells of the first RAN node;
receive, from the second RAN node, a second message in response to the first message; and
determine to perform network optimization based on the second message before or after handovers in each cell of the one or more cells.

2. The apparatus of claim 1, wherein the first message also indicates information of cells of the second RAN node to be impacted by the network optimization operations associated with the one or more cells of the first RAN node.

3. The apparatus of claim 2, wherein the second message indicates at least one of the following:
accepted cells to which the second RAN node allows the first RAN node to handover user equipment (UE);
rejected cells to which the second RAN node rejects the first RAN node to handover the UEs; or
suggested cells to which the second RAN node suggests the first RAN node to handover the UEs.

4. The apparatus of claim 2, wherein, for a cell of the second RAN node, the first information includes at least one of the following:
information of estimated energy cost when offloading traffic to the cell; or
information of an estimated user equipment (UE) performance when the UEs are to be handed over to the cell.

5. The apparatus of claim 2, wherein the first message also indicates information of the one or more cells of the first RAN node.

6. The apparatus of claim 1, wherein the first message also indicates information of the network optimization operations.

7. The apparatus of claim 1, wherein the at least one processor is further configured to cause the apparatus to:
transmit, to the second RAN node, a fourth message requesting user equipment (UE) related feedback after UEs are handed over to the second RAN node; and
after handing over an associated UE to the second RAN node, receive the UE related feedback of the associated UE or information indicating a stop providing the UE related feedback of the associated UE.

8. The apparatus of claim 7, wherein the at least one processor is further configured to cause the apparatus to transmit a plurality of fourth messages, wherein different fourth messages are associated with different types of UE related feedback.

9. The apparatus of claim 8, wherein the at least one processor is further configured to cause the apparatus to:
transmit identification information of at least one of the plurality of fourth messages to the second RAN node in a handover request message for the associated UE; or
indicate to the second RAN node that all types of UE related feedback are requested in a handover request message for the associated UE.

10. The apparatus of claim 7, wherein the information indicating the stop providing the UE related feedback of the associated UE indicates:
an indicator indicating the stop providing the UE related feedback;
one or multiple indicators indicating causes of the stop providing the UE related feedback;
a radio resource control (RRC) state entered by the associated UE;
identification information of a cell to which the associated UE is handed over by the second RAN node; or
identification information of a RAN node to which the associated UE is handed over by the second RAN node.

11. The apparatus of claim 7, wherein the information indicating the stop providing the UE related feedback is included in an information element (IE) that is the same as or different from an IE used to provide the UE related feedback.

12. The apparatus of claim 7, wherein the information indicating the stop providing the UE related feedback for the associated UE is included a UE context release message.

13. The apparatus of claim 7, wherein the UE related feedback comprises: UE performance feedback, UE mobility feedback, or UE traffic feedback.

14. An apparatus for wireless communication, comprising:
at least one memory; and
at least one processor coupled with the at least one memory and configured to cause the apparatus to:
receive, from a first radio access network (RAN) node by a second RAN node, a first message requesting first information related to network optimization operations associated with one or more cells of the first RAN node, wherein each network optimization operation is related to a cell of the one or more cells and is to be performed before or after handovers in the cell; and
transmit, from the second RAN node, a second message in response to the first message.

15. A method performed by a first radio access network (RAN) node, the method comprising:
transmitting to a second RAN node a first message requesting first information related to network optimization operations associated with one or more cells of the first RAN node, wherein each network optimization operation is related to a cell of the one or more cells;
receiving, from the second RAN node, a second message in response to the first message; and
determining to perform network optimization based on the second message before or after handovers in each cell of the one or more cells.

16. The method of claim 15, wherein the first message also indicates information of cells of the second RAN node to be impacted by the network optimization operations associated with the one or more cells of the first RAN node.

17. The method of claim 16, wherein the second message indicates at least one of the following:
accepted cells to which the second RAN node allows the first RAN node to handover user equipment (UE);
rejected cells to which the second RAN node rejects the first RAN node to handover the UEs; or
suggested cells to which the second RAN node suggests the first RAN node to handover the UEs.

18. The method of claim 16, wherein, for a cell of the second RAN node, the first information includes at least one of the following:
information of estimated energy cost when offloading traffic to the cell; or
information of an estimated user equipment (UE) performance when the UEs are to be handed over to the cell.

19. The method of claim 15, further comprising:
transmitting, to the second RAN node, a fourth message requesting user equipment (UE) related feedback after UEs are handed over to the second RAN node; and
after handing over an associated UE to the second RAN node, receiving the UE related feedback of the associated UE or information indicating a stop providing the UE related feedback of the associated UE.

20. A method performed by a second random access network (RAN) node, the method comprising:
receiving, from a first radio access network (RAN) node, a first message requesting first information related to network optimization operations associated with one or more cells of the first RAN node, wherein each network optimization operation is related to a cell of the one or more cells and is to be performed before or after handovers in the cell; and
transmitting a second message in response to the first message.
